(19) United States
(12) Patent Application Publication
(10) Pub. No.: US 2013/0093964 A1
(43) Pub. Date: Apr. 18, 2013

(54) LIGHTING DEVICE, DISPLAY DEVICE AND TELEVISION DEVICE

(71) Applicant: Tatsuro Kuroda, Osaka-shi (JP)

(72) Inventor: Tatsuro Kuroda, Osaka-shi (JP)

(73) Assignee: SHARP KABUSHIKI KAISHA, Osaka-shi, Osaka (JP)

(21) Appl. No.: 13/805,776

(22) PCT Filed: May 25, 2011
(86) PCT No.: PCT/JP2011/061936

§ 371 Date: Dec. 20, 2012

(30) Foreign Application Priority Data
Jun. 30, 2010 (JP) 2010-149381

(51) Int. Cl. F21V 21/00

(52) U.S. Cl. CPC F21V 21/00
USPC 348/739; 362/225; 362/97.1; 362/97.2

(57) ABSTRACT

It is an object of the present invention to provide a lighting device including a chassis, a lamp, and a lamp holder for mounting the lamp on the chassis, in which the lamp is less likely to be damaged due to warping or distortion of the chassis. A backlight according to the present invention includes linear cold cathode fluorescent tubes arranged in parallel with each other, a chassis housing the cold cathode fluorescent tubes, and lamp clips mounting the cold cathode fluorescent tubes on the chassis. The lamp clips are each arranged at least 0.125X away from ends of the chassis in an axial direction of the cold cathode fluorescent tube, in which is a length of the chassis measured in the axial direction of the cold cathode fluorescent tube.

### TECHNICAL FIELD

The present invention relates to a lighting device, a display device and a television device.

### BACKGROUND ART

A liquid crystal panel used in a liquid crystal display device such as liquid crystal television does not emit light, and thus the liquid crystal panel requires a backlight as a separate external lighting device. The backlight is arranged behind the liquid crystal panel (on a side opposite to a display surface). The backlight includes a chassis made of metal or resin with an opening on the liquid crystal panel side and a plurality of lamps (for example, cold cathode fluorescent tubes) housed in the chassis as lamps.

In recent years, a length of a tubular lamp increases along with an increase in the size of the liquid crystal display device. In such a long tubular lamp, not only each end portion, but also a middle portion thereof needs to be fixed onto the chassis, and thus a lamp clip is employed (for example, see Patent Document 1). The lamp clip disclosed in Patent Document 1 includes a mounting portion attached to a chassis, a lamp gripping portion protruding from the mounting portion toward a front side, and a fixing portion protruding from the mounting portion toward a rear side. The lamp gripping portion holds the middle portion of a cold cathode fluorescent tube. The fixing portion fixes the lamp clip to the chassis.

### RELATED ART DOCUMENT

Patent Document
Patent Document 1: Japanese Unexamined Patent Application Publication No. 2001-210126

### Problem to be Solved by the Invention

If a lighting device employs the above-described lamp clip, stress may be applied to the lamp via the lamp clip when the chassis is warped or distorted. If the chassis is warped or distorted in the axial direction of the lamp, different stress vectors act on end portions and portions of the lamp held by the lamp gripping portions. This may damage or break the lamp. The stress applied to the lamp in the axial direction of the lamp due to the warp or distortion of the chassis largely varies in vector per unit length on portions corresponding to end portions of the chassis. This leads a problem of damage of the lamp on the portions corresponding to the end portions of the chassis.

In addition, the number of lamp clips required for one lamp is increased with the increase in the length of the lamp. The increased number of lamp clips for one lamp means that the lamp is held at more positions. This leads an application of stress at more positions, and the lamp may be easily damaged.

### DISCLOSURE OF THE PRESENT INVENTION

The present invention was accomplished in view of the foregoing circumstances. An object of the present invention is to provide a lighting device in which the lamp is less likely to be broken.

### Means for Solving the Problem

A lighting device includes linear lamps arranged in parallel with each other, a chassis housing the linear lamps, and a plurality of lamp holders mounting the linear lamps on the chassis. The lamp holders are each arranged at least 0.125X inwardly away from ends of the chassis in an axial direction of the linear lamps, in which X is a length of the chassis measured in the axial direction of the linear lamps.

In this configuration, the lamp holders are not provided on end portions of the chassis depending on the length of chassis, and thus the lamp is hardly or less likely to be damaged due to the warping or distortion of the chassis. Specifically, on the end portions of the chassis that are easily deformed due to the warping or distortion, stress is not applied to the lamp through the lamp holder, and thus the lamp is hardly damaged.

The following configurations may be preferably employed as embodiments according to the present invention.

(1) Each of the linear lamps is held at an equal number of positions by the lamp holders. With this configuration, every lamp is equally hardly damaged. Specifically, each of the lamps receives the stress at the same number of positions through the lamp clips, and thus the stress applied to each lamp can be equalized and the concentration of stress to a specific lamp may not occur.

(2) Each of the linear lamps is held at at least three positions by the lamp holders. With this configuration, the linear lamp can be held by the lamp holder at three positions, and thus not only the linear lamp having a short length, but also the linear lamp having a long length can maintain its shape and can be held at predetermined positions.

(3) The lamp holders are provided at regular intervals in the axial direction of the linear lamps for each of the linear lamps. With this configuration, the linear lamp can be held over the entire length thereof, and thus the linear lamp can maintain its shape and can be held at predetermined positions.

(4) The lamp holders arranged in the axial direction of the linear lamps are arranged in a staggered manner in an arrangement direction of the linear lamps. With this configuration, a specific part of an optical path is not affected by the lamp clips, and thus uneven brightness is less likely to occur.

### Advantageous Effect of the Invention

In the lighting device in which the lamp is attached to the chassis by the lamp holder, the lamp is hardly or less likely to be damaged due to the warping or distortion of the chassis.

### BRIEF DESCRIPTION OF THE DRAWINGS

FIG. 1 is an exploded perspective view illustrating a general construction of a television device according to the first embodiment of the present invention;

FIG. 2 is a plan view of a backlight;

FIG. 3 is a cross-sectional view taken along a line A-A in FIG. 2; and

FIG. 4 is an enlarged cross-sectional view of a lamp gripping portion and a chassis fixing portion included in a lamp clip.

### MODE FOR CARRYING OUT THE INVENTION

### Embodiment

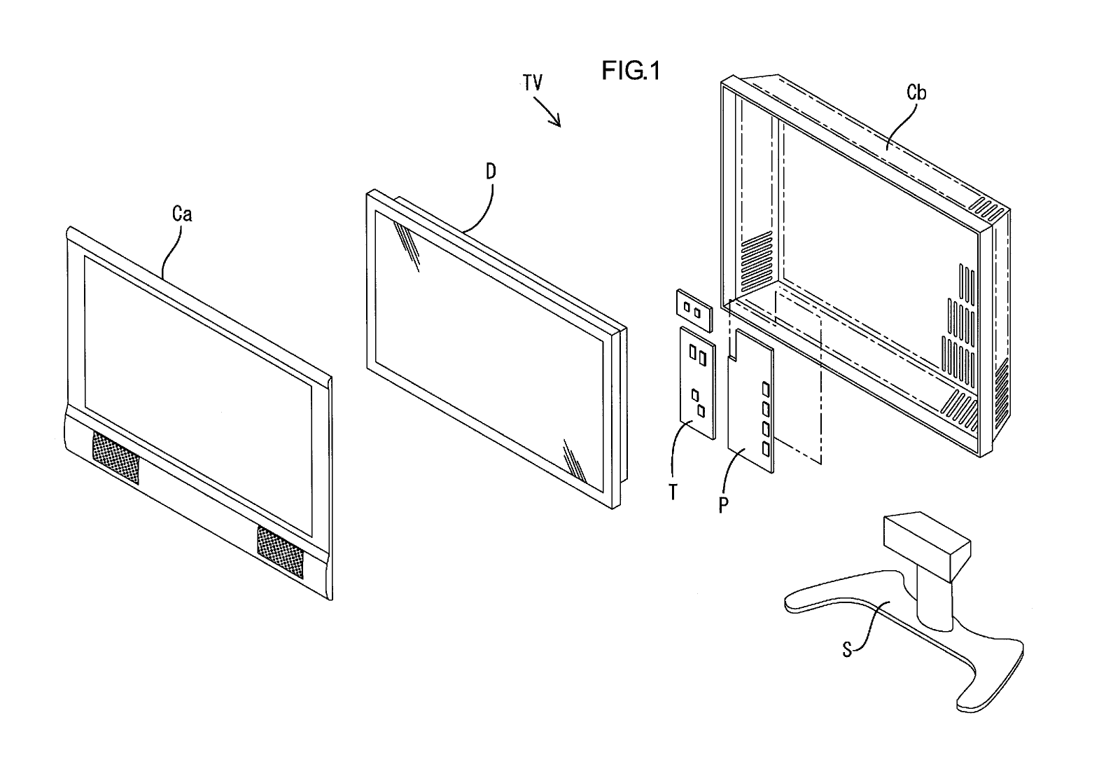

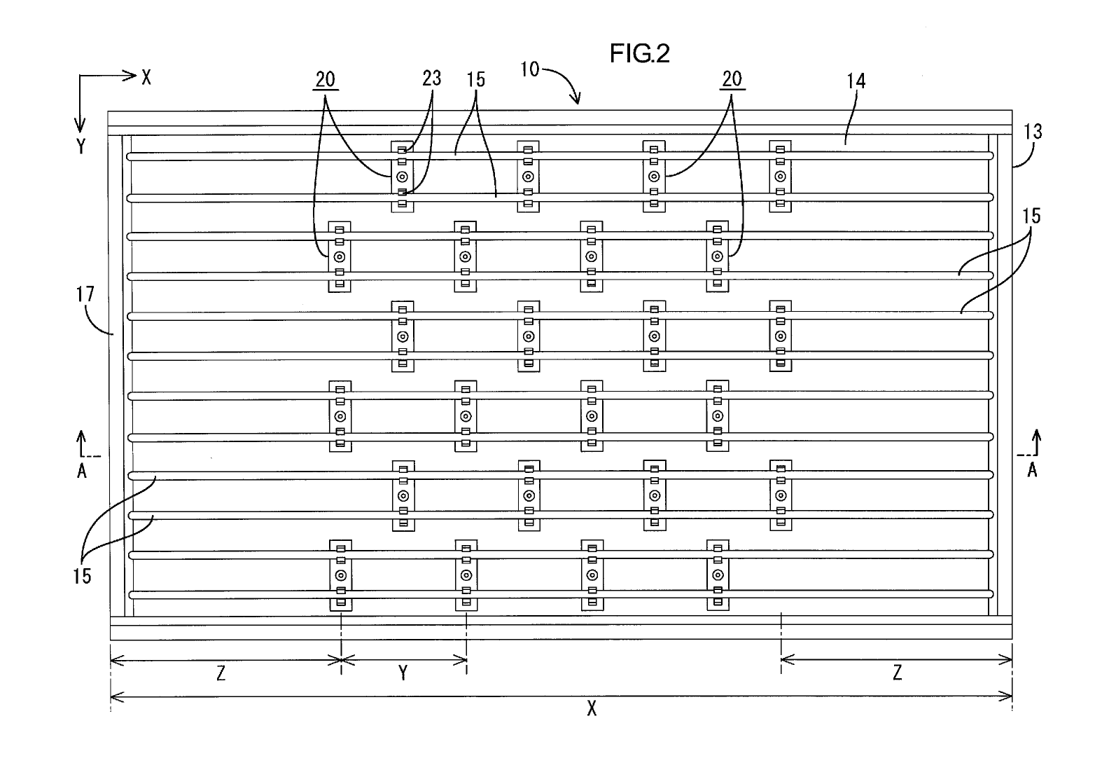

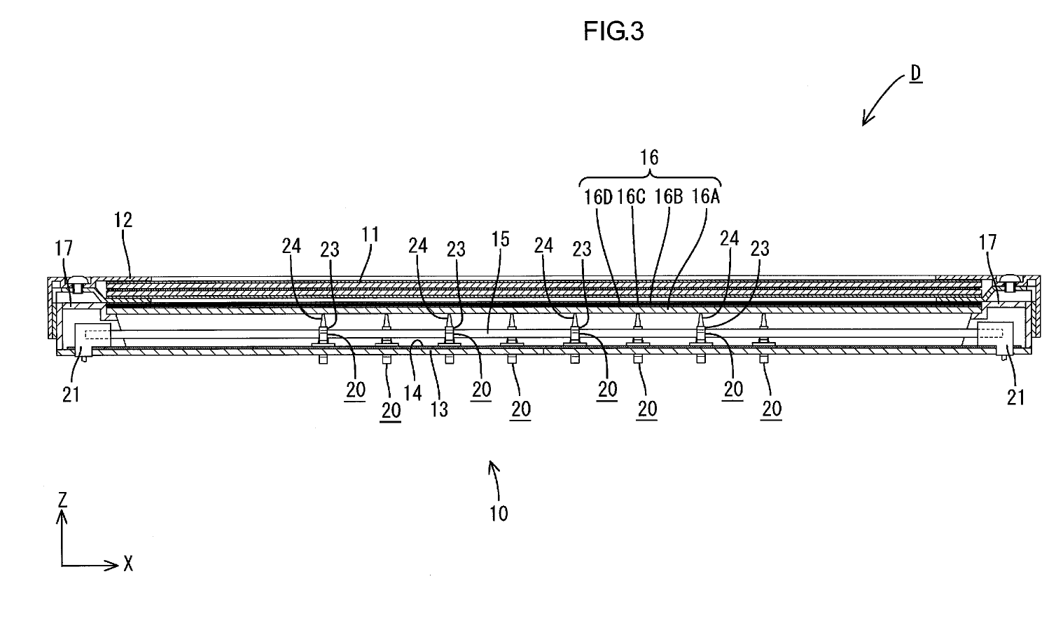

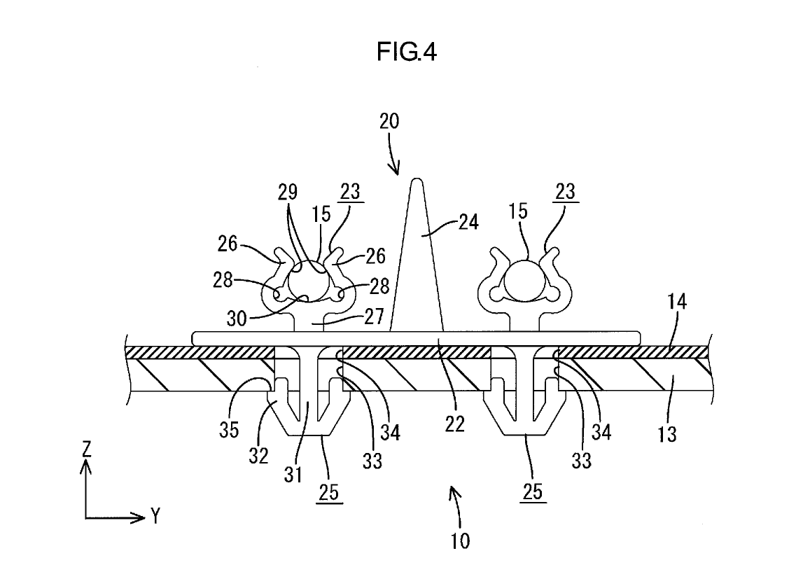

The embodiment according to the present invention will be explained with reference to FIG. 1 to FIG. 4. In the present embodiment, a liquid crystal display device D will be described as an example of a display device. An X-axis, a Y-axis and a Z-axis are described in a part of some drawings. The axes in each drawing correspond to the respective axes in other drawings. The upper side and the lower side in FIG. 3 and FIG. 4 correspond to the front side and the rear side (the Z-axis direction in FIG. 3 and FIG. 4), respectively. A right-to-left direction is based on FIG. 2 and FIG. 3 (the X-axis direction in FIG. 2 and FIG. 3).

As illustrated in FIG. 3, the liquid crystal display device D has a landscape quadrangular shape (rectangular shape) as a whole. The liquid crystal display device D includes a liquid crystal panel 11 as a display panel on which an image can be displayed, a backlight 10 as an external light source (a lighting device) configured to emit light toward the liquid crystal panel 11, and a bezel 12 covering and connecting the liquid crystal panel 11 and the backlight 10 from the front side of the liquid crystal panel 11. The liquid crystal display device D can be used in a television device TV. The television device TV includes the liquid crystal display device D, front and rear cabinets Ca, Cb which house the liquid crystal display device D therebetween, a power source P, a tuner T, and a stand S.

As illustrated in FIG. 3, the liquid crystal panel 11 has a well-known structure. Specifically, the liquid crystal panel 11 is configured such that a transparent TFT substrate and a transparent CF substrate are bonded with each other with a predetermined gap therebetween, and liquid crystal whose optical characteristics vary with applied voltage is sealed between the substrates. On the TFT substrate, TFTs (Thin Film Transistor) connected to source lines and gate lines which are perpendicular to each other are provided as switching components. On the CF substrate, color filters having three color sections in red (R), green (G) and blue (B) arranged in a matrix are provided. In addition, a polarizing plate is attached to each of the substrates on a side opposite to the liquid crystal.

The backlight 10 includes a chassis 13 with an opening on a front side, which is a light exit side, a reflection sheet arranged in the chassis 13, a plurality of cold cathode fluorescent tubes 15 (tubular lamps) housed in the chassis, an optical member 16 arranged between the cold cathode fluorescent tubes 15 and the liquid crystal panel 11, and a plurality of lamp clips 20 (lamp holding member) holding the cold cathode fluorescent tubes 15. The backlight 10 is a direct-type back light in which the cold cathode fluorescent tubes 15 are arranged behind the liquid crystal panel 11.

The chassis 13 is made of metal. As illustrated in FIG. 2, the chassis 13 has a box-like shape including a rectangular bottom plate and side plates rising from each long-side of the bottom plate. The chassis 13 has a bottom surface arranged substantially parallel to the liquid crystal panel 11. The size of the chassis 13 is determined based on the size of the liquid crystal panel 11 to which the backlight 10 is attached. For example, 52-inch liquid crystal panel 11 has a long side of about 1200 mm and a short side of about 680 mm.

The reflection sheet 14 is made of a synthetic resin and has a front surface having a white color that provides high light reflectivity. As illustrated in FIG. 2 and FIG. 3, the reflection sheet 14 is integrally arranged over substantially entire of an inner surface of the chassis 13. The reflection sheet 14 guides the light emitted from the cold cathode fluorescent tubes 15 to the opening of the chassis 13.

As illustrated in FIG. 2 and FIG. 3, the cold cathode fluorescent tube 15 is a linear light source extending in one direction along the bottom surface of the chassis 13 and the front surface of the optical member 16. The cold cathode fluorescent tubes 15 are arranged in the chassis 13 such that the axial direction thereof matches the long-side direction of the chassis 13. The cold cathode fluorescent tubes 15 are arranged substantially parallel with each other with predetermined intervals therebetween. The spaces (distances) between the cold cathode fluorescent tubes 15 adjacent to each other are substantially the same.

The cold cathode fluorescent tube 15 in this case includes an elongated glass tube having a circular cross-section. Mercury is provided inside the glass tube and a fluorescent material is applied on inner surface of the glass tube. Further, electrodes are sealed on end portions of the glass tube. The cold cathode fluorescent tube 15 has a diameter of a few millimeters and a length of about tens of centimeters to 1.5 meters. The entire shape of the cold cathode fluorescent tube 15 is long and thin. To a non-light emitting portion at each end portion of the cold cathode fluorescent tube 15, a rubber holder 21 to be attached to the chassis 13 is attached. The rubber holder 21 is inserted into the holes formed in the bottom surface of the chassis 13 and the reflection sheet 14. From the rubber holder 21, an end portion of a lead is drawn, and the end portion of the lead is connected to an inverter board (not illustrated) on a rear side of the chassis 13. The other end of the lead is soldered to a terminal of the electrode of the cold cathode fluorescent tube 15.

As illustrated in FIG. 3, the optical member 16 has a rectangular shape in plan view. The optical member 16 is made of a light transmissive synthetic resin and is attached to the opening of the chassis 13 so as to be located between the cold cathode fluorescent tubes 15 and the liquid crystal panel 11. The optical member 16 includes a diffuser plate 16A, a diffuser sheet 16B, a lens sheet 16C, and a brightness increasing sheet 16D in this order from the rear side. The optical member 16 converts the light emitted from the cold cathode fluorescent tubes 15 as the linear light sources to a planar light, for example. The diffuser plate 16A located on the most rear side has a larger thickness than the other sheets 16B to 16D and has a relatively high rigidity.

The lamp holder 17 is made of a synthetic resin and has a white surface. As illustrated in FIG. 2 and FIG. 3, the lamp holder 17 is attached to each end of the chassis 13 in the long-side direction and extends along the short side of the chassis 13. The lamp holder 17 has a box-like shape with an opening on the rear side and covers the rubber holders 21 attached to the cold cathode fluorescent tubes 15 from the front side. The lamp holder 17 includes a stepped receiving section on an inner peripheral portion to receive the optical members 16.

As illustrated in FIG. 4, the lamp clip (the lamp holder) 20 includes a main body 22 having a flat plate shape extending along the bottom surface of the chassis 13 and the surface of the optical member 16. The main body 22 has a substantially rectangular shape elongated in the short-side direction of the chassis 13. On an upper surface (a front surface, a surface facing the optical member 16 and the cold cathode fluorescent tube 15) of the main body 22, lamp gripping portions 23 and a supporting member 24 are provided to protrude toward the front side. On a rear surface (a rear surface, a surface facing the chassis 13 and the reflection sheet 14) of the main body 22, a fixing portion 25 is provided to protrude toward the rear side. The lamp clip 20 is made of a synthetic resin and has a white surface that provides high light reflectivity.

The lamp gripping portion 23 has an open-end ring shape and surrounds an outer peripheral part of the cold cathode fluorescent tube 15. The lamp gripping portion 23 is provided in a pair on the main body 22 with a predetermined distance therebetween in the long-side direction of the main body 22. Each of the lamp gripping portions 23 holds a separate cold cathode fluorescent tube 15. The lamp gripping portions 23 are provided on each main body 22 at substantially regular intervals corresponding to the distances between the cold cathode fluorescent tubes 15 adjacent to each other in the chassis 13. Specifically, each lamp gripping portion 23 includes a connecting portion 27 protruding from the upper surface of the main body 22 and a pair of arm portions 26 connected at base portions thereof by the connecting portion 27. With this configuration, the cold cathode fluorescent tube 15 can be held at a position above the main body 22. The distance between tip end portions of the arm portions 26 is smaller than the minimum outer diameter of the cold cathode fluorescent tube 15 measured between sections to be contacted with the tip end portions of the arm portion 26. The cold cathode fluorescent tube 15 can be attached to or removed from the lamp clip 20 through the gap between the tip end portions of the lamp gripping portions 23. In the attachment or removal of the cold cathode fluorescent tube 15, the arm portions 26 can be elastically deformed such that the tip end portions thereof are away from each other.

An inner surface (a surface facing the cold cathode fluorescent tube) provided by the pair of arm portions 26 includes three curved surfaces 29, 30 and two recesses 28 between the curved surfaces 29, 30. The recesses 28 are each positioned between a root portion at which the arm portion 26 starts to deform (portion connected to the connecting portion 27) and an open end portion. With this configuration, the arm portions 26 can be easily elastically opened and deformed. The curved surfaces 29, 30 are in point contact with the cold cathode fluorescent tube, and thus the cold cathode fluorescent tube 15 is supported at three points.

As illustrated in FIG. 4, two chassis fixing portions 25 are arranged on a lower surface of the main body 22 at positions substantially corresponding to the lamp gripping portions 23. The chassis fixing portion 25 includes a base portion 31 extending from the lower surface of the main body 22 and a pair of elastic stoppers 32 extending upward from a tip end portion of the base portion 31 (toward the main body 22 with a distance between the base portion 31 and the elastic stoppers 32 increased). The base portion 31 has an elongated rectangular bottom surface in plan view along the short-side direction of the main body 22. The elastic stoppers 32 each have a cantilevered shape and connected to the long side of the tip end portions. The elastic stoppers 32 can be elastically deformed from the connected portion in a direction away from the base portion 31 (in the horizontal direction illustrated in FIG. 4, which intersects with an attachment direction with respect to the chassis 14). A part of the outer circumferential surface of the elastic stopper 32 that extends along the long-side direction of the base portion 31 having a rectangular shape in bottom view has a curved shape so as to fit with a mounting hole 33, which will be described later.

The above-described chassis fixing portion 25 can be inserted into the mounting hole 33 formed in the chassis 13. The chassis fixing portion 25 can be stopped at an outer periphery of the mounting hole 33, and thus the lamp clip 20 can be fixed to chassis 13. The mounting holes 33 are formed in the bottom surface of the chassis 13 at positions corresponding to the mounting positions of the lamp clips 20. Two mounting holes 33 are provided for each lamp clip 20. Further, insertion holes 34 are formed in the reflection sheet 14 at positions corresponding to the mounting holes 33 formed in the chassis 13. The insertion holes 34 are communicated with the mounting holes 33 such that the chassis fixing portions 25 are inserted therethrough.

As illustrated in FIG. 4, the elastic stoppers 32 of the chassis fixing portion 25 each include an inclined portion extending obliquely upward from a tip end of the base portion 31 and a straight portion extending straight upwardly from the end of the inclined potion. An end portion of each elastic stopper 32 is made as a stopper portion 35 that can be stopped by a rear surface around the mounting hole 33. The stopper portion 35 is obtained by cutting an outer peripheral portion of the end portion of the elastic stopper along the long side of the base portion 31 in a stepped shape. A surface of the stopper portion 35 that is stopped by the rear surface (back surface) around the mounting hole 33 is substantially parallel (horizontal) with the lower surface of the chassis 13. An outer surface of the stopper portion 35 that faces an inner surface of the mounting hole 33 extends vertically and has a curved shape corresponding to the mounting hole 33. The outer surface of the stopper portion 35 is in contact with or closely positioned to the inner surface of the mounting hole 33, and thus there is almost no space therebetween.

As illustrated in FIG. 2 and FIG. 3, the lamp clips are arranged on the bottom surface of the chassis 13, specifically, on the front surface of the reflection sheet 14. An arrangement of the lamp clips 20 will be described below. The lamp clips 20 are each arranged at least 0.125X away from the right end and the left end of the chassis in the axial direction of the cold cathode fluorescent tube 15 in a dispersed manner. “X” is the length of the chassis 13 along the axial direction of the cold cathode fluorescent tube 15. That is, no lamp clips 20 are arranged in an area from the right end and the left end of the chassis 13 to the position 0.125X away from the right end and the left end of the chassis in the axial direction of the cold cathode fluorescent tube 15. The symbol “Z” in FIG. 2 indicates a distance between the right end of the chassis 13 and the lamp clip 20 closest to the right end or a distance between the left end of the chassis 13 and the lamp clip closest to the left end. The distance indicated with Z is at least 0.125X.

As illustrated in FIG. 2, the lamp clips 20 are arranged at regular intervals Y in the axial direction of the cold cathode fluorescent tube 15 (for example, at intervals of 120 mm). Further, the lamp clips 20 arranged in the axial direction of the cold cathode fluorescent tube 15 are arranged in a staggered manner (in a zigzag manner) in an arrangement direction of the cold cathode fluorescent tubes 15. Specifically, four lamp clips are arranged at four positions Z, Z+Y, Z+2Y, Z+3Y away from the right end or the left end of the chassis 13. The lamp clips 20 arranged a predetermined distance away from the left end and the right end are arranged alternately in the arrangement direction of the cold cathode fluorescent tubes 15.

As illustrated in FIG. 2, a pair of cold cathode fluorescent tubes 15 adjacent to each other in the arrangement direction of the cold cathode fluorescent tubes 15 is held by four lamp clips 20. In the present embodiment, 12 cold cathode fluorescent tubes 15 are held by 24 pairs of lamp gripping portions 23 included in the lamp clips 20, and thus each cold cathode fluorescent tube 15 is held at four positions.

As described above, according to the present embodiment, the lamp clips 20 are each arranged at least 0.125X away from the right end and the left end of the chassis 13. Accordingly, the stress caused by the deformation of the chassis 13 within 0.125X from the right end and the left end, which likely to damage the cold cathode fluorescent tube 15, is less likely to act on the cold cathode fluorescent tube 15 through the lamp clip 20, and thus the cold cathode fluorescent tube 15 is less likely to be damaged.

Specifically, since the lamp clip 20 is fixed to the chassis 13 via the chassis fixing portion 25 and the lamp gripping portion 23 of the lamp clip 20 holds the cold cathode fluorescent tube 15, the lamp clip 20 applies stress onto the cold cathode fluorescent tube 15 in response to the deformation of the chassis 13. If the backlight 10 is subjected to stress and the bottom surface of the chassis 3 (a mounting surface of the cold cathode fluorescent tube 15) is warped or distorted, or if the bottom surface of the chassis 13 is horizontally placed and the chassis 13 is deformed by its own weight, the bottom surface of the chassis 13 is deformed, particularly around the peripheral edge thereof rather than the middle portion thereof. In other words, the amount of displacement in the vertical direction (the Z-axis direction) per unit length of the bottom surface of the chassis tends to be small on the middle portion of the chassis 13, but large around the peripheral edge of the chassis 13. In the present embodiment, since the cold cathode fluorescent tubes 15 are arranged to extend along the long-side direction (the X-axis direction) of the chassis 13, the deformation of the cold cathode fluorescent tube 15 in the long-side direction should be considered. However, in the present embodiment, the lamp clips 20 are not arranged within 0.125X from the right end and the left end of the chassis 13, i.e., no lamp clips 20 are arranged in the area of the chassis 13 where the deformation is likely to occur compared with the area at least 0.125X away from the right end and the left end of the chassis 13. This leads the reductions in the stress acting on the cold cathode fluorescent tube 15. If the lamp clip 20 is arranged within 0.125X from the right end and the left end of the chassis, a large stress may act on the cold cathode fluorescent tube 15 with the deformation of the chassis 13, and the cold cathode fluorescent tube 15 may be broken.

Each cold cathode fluorescent tube 15 is held at four positions by the lamp clips 20. Thus, when the chassis 13 is warped or distorted, each cold cathode fluorescent tube 15 is subjected to four different stress vectors through the lamp clips 20. The stress vectors acting on the cold cathode fluorescent tubes 15 at the portions held by the lamp clips 20 vary, but at least, every cold cathode fluorescent tube 15 is subjected to stress at four positions. Accordingly, the stress equally acts on each cold cathode fluorescent tube 15, and thus the cold cathode fluorescent tubes 15 are equally less likely to be damaged.

The lamp clips 20 are arranged in the axial direction of the cold cathode fluorescent tube 15 at positions Z, Z+Y, Z+2Y, Z+3Y away from the left end or the right end of the chassis 13. If the chassis 13 is symmetrically deformed with respect to the middle line of the left end and the right end, the cold cathode fluorescent tubes 15 are subjected to the equal stress. Accordingly, the cold cathode fluorescent tubes 15 are equally likely to be deformed.

Since the lamp clips 20 are arranged at regular intervals in the axial direction of the cold cathode fluorescent tube 15, the cold cathode fluorescent tube 15 is less likely to be warped or distorted over entire length thereof, compared with the case in which the lamp clips 20 are locally arranged. Thus, the cold cathode fluorescent tube 15 is less likely to be damaged due to the deformation caused by its own weight.

In the present embodiment, the lamp clips 20 hold the cold cathode fluorescent tube 15 at four positions. The present embodiment can hold a longer cold cathode fluorescent tube 15 than the technology including the lamp clip(s) that hold(s) the cold cathode fluorescent tube 15 at one or two positions.

In addition, in the present embodiment, the lamp clips 20 are arranged in a stagger manner in the arrangement direction of the cold cathode fluorescent tubes 15. With this configuration, the lamp clips 20 are less likely to affect the optical path at a specific part, compared with the case in which the lamp clips 20 are arranged adjacent to each other in the arrangement direction of the cold cathode fluorescent tubes 15, and thus the uneven brightness is less likely to occur.

To reduce damage of the cold cathode fluorescent tube 15 due to warping or distortion of the chassis 13, the cold cathode fluorescent tube 15 may be reinforced, or the chassis 13 may be configured to have less warping or less distortion. However, in the present embodiment, such considerations are unnecessary. Conversely, according to the present embodiment, by slightly changing the design, for example changing the positions of mounting holes 33 for mounting the lamp clips 20 to the chassis 13, the cold cathode fluorescent tube 15 can be hardly or less likely to be damaged by the warping or distortion of the chassis 13. This requires only existing members.

### Other Embodiments

The present invention is not limited to the above embodiments described in the above description and the drawings. The following embodiments are also included in the technical scope of the present invention, for example.

(1) In the above embodiment, the lamp clip includes a pair of lamp gripping portions. However, the lamp clip may include one lamp gripping portion or three or more lamp gripping portions. For example, the number of lamp gripping portions included in one lamp clip may correspond to the number of lamps housed in the chassis.

(2) In the above embodiment, the lamp clip holds the cold cathode fluorescent tube at the lamp gripping portion including two arm portions in contact with the cold cathode fluorescent tube. However, as long as the lamp clip has a configuration for holding the cold cathode fluorescent tube, the shape of the lamp gripping portion may be suitably changed.

(3) In the above embodiments, the lamp clips are fixed on the chassis by two lamp fixing portions stopped at the peripheral edge of the mounting hole of the chassis. However, as long as the lamp clips are fixed on the chassis, the number of fixing members or how to fix the lamp clip may be changed.

(4) The number of lamp clips and the number of cold cathode fluorescent tubes per backlight may be suitably changed.

(5) In the above embodiments, the cold cathode fluorescent tubes adjacent to each other are arranged at substantially regular intervals. However, the cold cathode fluorescent tubes adjacent to each other may be arranged at irregular intervals. For examples, on the middle section of the chassis in the arrangement direction of the cold cathode fluorescent tubes, the cold cathode fluorescent tubes may be densely arranged.

(6) In the above embodiments, a case made of metal is used. However, a case made of resin may be used. In such a case, a reflection sheet as a separate member may not be provided if an inner surface of the case is in color or material that provides the same reflectivity as the reflection sheet. To provide reflectivity same as the reflection sheet to only an inner surface of the case, paints having reflectivity may be applied to the inner surface of the case made of resin, or the case may be formed by double molding.

(7) The technology described above can be applied to liquid crystal display devices including switching components other than TFTs. Moreover, the technology can be applied to not only color liquid crystal display devices but also black-and-white liquid crystal display devices.

(8) The technology can be applied not only to the liquid crystal display device, but also to other display devices including the backlight.

### EXPLANATION OF SYMBOLS

10: backlight (lighting device), 11: liquid crystal panel (display panel), 12: bezel, 13: chassis, 14: reflection sheet, 15: cold cathode fluorescent tube (lamp), 16: optical member, 17: lamp holder, 20: lamp clip (lamp holder), 21: rubber holder, 22: main body, 23: lamp gripping portion, 24: support, 25: chassis fixing portion, 26: arm portion, 27: connecting portion, 28: recess, 29, 30: curved surface, 31: base portion, 32: elastic portion, 33: mounting hole, 34: insertion hole, 35: stopper portion, D: liquid crystal display device

1. A lighting device comprising:
a plurality of linear lamps arranged in parallel with each other;
a chassis housing the linear lamps; and
a plurality of lamp holders mounting the linear lamps on the chassis,
wherein the lamp holders are each arranged at least 0.125X inwardly away from ends of the chassis in an axial direction of the linear lamps, in which X is a length of the chassis measured in the axial direction of the linear lamps.

2. The lighting device according to claim 1, wherein each of the linear lamps is held at an equal number of positions by the lamp holders.

3. The lighting device according to claim 1, wherein each of the linear lamps is held at at least three positions by the lamp holders.

4. The lighting device according to claim 1, wherein the lamp holders are provided at regular intervals in the axial direction of the linear lamps for each of the linear lamps.

5. The lighting device according to claim 1, wherein the lamp holders are arranged in the axial direction of the linear lamps in a staggered manner with respect to an arrangement direction of the linear lamps.

6. A display device comprising:
the lighting device for a display device according to claim 1; and
a display panel arranged behind the lighting device for the display device.

7. The display device according to claim 6, wherein the display panel is a liquid crystal display including a pair of substrates with liquid crystals sealed therebetween.

8. A television receiver comprising the display device according to claim 6.
